(19) United States
(12) Patent Application Publication
(10) Pub. No.: US 2026/0326360 A1
(43) Pub. Date: Oct. 22, 2026

(54) DAMPER HAVING CONDUCTIVE STRUCTURES WITH WIDE, THIN AND FLAT SHAPE, AND METHOD FOR MANUFACTURING THE SAME

(71) Applicant: Hiroko OHARA, Taoyuan County (TW)

(72) Inventor: Hiroko OHARA, Taoyuan County (TW)

(21) Appl. No.: 19/723,562

(22) Filed: Jun. 29, 2026

Related U.S. Application Data
(63) Continuation-in-part of application No. 18/244,402, filed on Sep. 11, 2023, now abandoned.

(30) Foreign Application Priority Data
May 19, 2023 (TW) 112118753

(51) Int. Cl. B29C 51/12; B29C 51/26; B29K 105/08; B29L 31/34; D03D 13/00; D03D 15/217; D03D 15/292; D03D 15/533; H04R 9/04

(52) U.S. Cl. CPC B29C 51/12; B29C 51/264; B29C 51/266; D03D 13/00; D03D 15/217; D03D 15/292; D03D 15/533; H04R 9/043; B29K 2105/0845; B29K 2995/0005; B29L 2031/3418; D10B 2101/20; D10B 2401/16

(57) ABSTRACT

Provided is a method for manufacturing a damper having conductive structures with wide, thin and flat shape, comprising: arranging warp yarns and two multifilament threads at intervals; weaving a base material by interweaving weft yarns with the warp yarns and the multifilament thread; impregnating the base material in a resin solution; drying the base material; thermoforming a main body and conductive structures on the base material, the conductive structures pushing the warp yarns to move away to form compliance adjustment sections with widths of W1, W2, . . . , Wn according to proximity, with a distance between the warp yarns not pushed by the conductive structures defined as D, where W1>W2> . . . >Wn>D; and separating the main body from the base material, and the conductive structures from the multifilament thread.

### CROSS-REFERENCE TO RELATED APPLICATION

This application claims the priority of Taiwanese patent application No. 112118753, filed on May 19, 2023, which is incorporated herewith by reference.

### BACKGROUND OF THE INVENTION

### 1. Field of the Invention

The present invention relates to a damper and a method for manufacturing the same, and more particularly, to a damper having conductive structures with a wide, thin and flat shape, and a method for manufacturing the same.

### 2. The Prior Arts

In the moving coil loudspeaker, the conductive structures function as transmitting alternating current with power to the voice coil, and the damper functions as maintaining the voice coil at the correct position in the gap of the iron core of the magnet, so as to ensure that the voice coil reciprocates along the axis direction when being forced. The conductive structures are fixed on the main body of the damper, and the main body can support the conductive structures, thereby increasing the fatigue resistance of the conductive structures without being easily broken.

The conductive structures can be fixed on the main body of the damper by a sewing thread. However, a manual operation of a sewing machine is required to sew and fix the conductive structures on the surface of the main body of the damper by the sewing thread. Furthermore, the steps are quite complicated.

Although the conductive structures can be sandwiched between two main bodies, in the thermoforming process, the position of the conductive structures will shift away from the optimal position, thereby affecting the common resonance efficiency of the damper, the voice coil, and the diaphragm. Furthermore, the shifting conditions of the positions of the conductive structures in each damper are different from each other, resulting in that the sound quality of respective loudspeakers are slightly different from each other. In addition, the steps are quite complicated.

Further, because the rigidity of the conductive structures is higher than that of ordinary yarns, and the warp yarns and weft yarns around the conductive structures are typically constrained by penetration or curing of the adhesive, it is difficult for the warp yarns and weft yarns around the conductive structures to move away from the conductive structures. As a result, the flexibility of the conductive structures and the weft yarns passing through the conductive structures is restricted, causing the compliance of the conductive structures and the weft yarns passing through the conductive structures to be significantly lower than regions consisting solely of weft yarns, which results in increased local rigidity and reduced deformation capacity in the formation of the damper.

The cross-section of conventional conductive structure is circular, and the circular conductive structure is usually formed by blend-twisting a plurality of metal yarns. The part of each metal yarn located in the center are covered by other metal yarns, which causes the heat generated to be difficult to dissipate and results in problem of heat accumulation, thereby causing the circular conductive structure to easily overheat.

Furthermore, the circular conductive structure is relatively thick, and protrudes a lot from the surface of the main body of the damper, resulting in that the circular conductive structure is easily crushed by the mold, or even broken.

In addition, the ends of the circular conductive structure formed by blend-twisting are in a state of spreading apart, which is not easy to be joined to the contact point of the connecting terminal and the coil of the voice coil by dispensing.

Moreover, the dispensing glue is easy to age and loses its viscosity, causing the ends of the circular conductive structure to spread apart easily, and then separate from the contact points of the connecting terminals and the coil of the voice coil.

Also, the general metal yarn is entirely made of metal, so that the cost is relatively high.

In addition, these metal yarns must be in a count of at least twenty so as to be blend-twisted into a circular conductive structure, so that the manufacturing cost is relatively high.

### SUMMARY OF THE INVENTION

The main objective of the present invention is to provide a damper having conductive structures with a wide, thin and flat shape and a method for manufacturing the same, which utilizes weft yarns to fix the multifilament threads, so that the sewing thread is not required at all.

Another objective of the present invention is to provide a damper having conductive structures with a wide, thin and flat shape and a method for manufacturing the same, which utilizes weft yarns to fix the multifilament threads, such that in the process of thermoforming, the multifilament threads are ensured not to shift, and after being cut, the conductive structures are ensured to be in the optimal position.

Yet another objective of the present invention is to provide a damper having conductive structures with a wide, thin and flat shape and a method for manufacturing the same, wherein the warp yarns and weft yarns around the conductive structures can move away from the conductive structures.

Still another objective of the present invention is to provide a damper having conductive structures with a wide, thin and flat shape and a method for manufacturing the same, wherein the shape of the conductive structures and the weaving method for the metal yarns allow the metal yarns to be exposed to outside without being covered by other metal yarns.

Another objective of the present invention is to provide a damper having conductive structures with a wide, thin and flat shape and a method for manufacturing the same, which has a lower risk of crushing the conductive structures.

Yet another objective of the present invention is to provide a damper having conductive structures with a wide, thin and flat shape and a method for manufacturing the same, wherein due to the soldering parts, the ends of the conductive structures can be joined to the connecting terminals and the voice coil without spreading apart.

Still another objective of the present invention is to provide a damper having conductive structures with a wide, thin and flat shape and a method for manufacturing the same, wherein due to the composition of the metal yarns, the cost can be reduced, and a certain level of electrical conductivity can be maintained.

Yet another objective of the present invention is to provide a damper having conductive structures with a wide, thin and flat shape and a method for manufacturing the same, wherein in the weaving method for the metal yarns, a multifilament thread can be woven with a minimum count of yarns.

In order to achieve the above objectives, the present invention provides a method for manufacturing a damper having conductive structures with a wide, thin and flat shape, comprising the following steps: forming a plurality of metal yarns by covering an outer surface of a core thread with a metal layer for each metal yarn; weaving multifilament threads with a wide, thin and flat shape by interweaving a plurality of first interwoven parts of the plurality of metal yarns with a plurality of second interwoven parts of the plurality of metal yarns for each multifilament thread; wherein both ends of each of the first interwoven parts are respectively connected to one of the second interwoven parts, the first interwoven parts are parallel to each other, the second interwoven parts are parallel to each other, and an extension direction of the first interwoven parts is different from that of the second interwoven parts; arranging a plurality of warp yarns and two multifilament threads at intervals with at least two of the warp yarns located between the multifilament threads, wherein the warp yarns and the multifilament threads extend straightly and are parallel to each other; weaving a base material by interweaving a plurality of weft yarns with the warp yarns and the multifilament threads; impregnating the base material in a resin solution; drying the base material; thermoforming a main body of a damper on the base material, and two conductive structures with the wide, thin and flat shape on the multifilament threads, simultaneously, wherein under influence of temperature and pressure, the conductive structures push the warp yarns close to the conductive structures to move away from the conductive structures, such that a plurality of compliance adjustment sections are formed between the warp yarns closest to the conductive structures and the conductive structures, as well as between the warp yarns pushed by the conductive structures; widths of the compliance adjustment sections are defined as W1, W2, . . . , and Wn, respectively, according to their proximity to the conductive structures, where n≥1 and n is a positive integer; a distance between remaining warp yarns that are not pushed by the conductive structures is defined as D, where W1>W2> . . . >Wn>D; and separating the main body from the base material, and the conductive structures from the multifilament threads, simultaneously.

In some embodiments, in the step of thermoforming the main body of the damper on the base material, two of the warp yarns closest to each of the conductive structures among the warp yarns pushed by the conductive structures are defined as closest warp yarns, and one of the warp yarns closest to each of the closest warp yarns among the warp yarns pushed by the conductive structures is defined as second-closest warp yarns; the conductive structures push the closest warp yarns to move away from the conductive structures, such that the weft yarns form a first compliance adjustment section between each of the closest warp yarns and each of the conductive structures; a residual force of the conductive structures pushing the closest warp yarns prompts the closest warp yarns to push the second-closest warp yarns to move away from the conductive structures, such that the weft yarns form a second compliance adjustment section between each of the second-closest warp yarns and each of the closest warp yarns; a width of the first compliance adjustment section is defined as W1, and a width of the second compliance adjustment section is defined as W2, where W1>W2>D.

In some embodiments, after the step of separating the main body from the base material, the method further comprises: soldering with tin at both ends of the conductive structures to form at least four tin soldering parts.

In some embodiments, a material of the core thread is cotton.

In some embodiments, the metal yarns are in a count of seven.

In some embodiments, in the step of thermoforming the main body of the damper on the base material, the base material is placed between a first mold and a second mold in a manner that the multifilament threads are aligned with two grooves of the first mold and two grooves of the second mold, and when the first mold and the second mold fit together, a pressing surface of the first mold and a forming surface of the second mold jointly pressurize the base material to form a plurality of wave portions and a center hole pre-cut area of the main body; and wherein each wave portion comprises a crest and a trough, the multifilament threads are located in the grooves of the first mold and the grooves of the second mold, and the pressing surface and the forming surface jointly pressurize the multifilament threads to form the conductive structures.

In order to achieve the above objectives, the present invention provides a damper having conductive structures with a wide, thin and flat shape, which comprises a main body and two conductive structures. The main body is formed by interweaving a plurality of warp yarns and a plurality of weft yarns. The conductive structures are in wide, thin and flat shape, and the conductive structures and the warp yarns are arranged at intervals with at least two of the warp yarns located between the conductive structures, extend straight, parallel to each other, and are interwoven with the weft yarns, wherein each of the conductive structures is a multifilament thread with a wide, thin and flat shape, and the multifilament thread is formed by interweaving a plurality of first interwoven parts of a plurality of metal yarns and a plurality of second interwoven parts of the plurality of metal yarns. Wherein each of the metal yarns is formed by covering an outer surface of a core thread with a metal layer, wherein both ends of each of the first interwoven parts are respectively connected to one of the second interwoven parts, the first interwoven parts are parallel to each other, the second interwoven parts are parallel to each other, and an extension direction of the first interwoven parts is different from that of the second interwoven parts. Wherein under influence of temperature and pressure, the conductive structures push the warp yarns close to the conductive structures to move away from the conductive structures, such that a plurality of compliance adjustment sections are formed between the warp yarns closest to the conductive structures and the conductive structures, as well as between the warp yarns pushed by the conductive structures; widths of the compliance adjustment sections are defined as W1, W2, . . . , and Wn, respectively, according to their proximity to the conductive structures, where n≥1 and n is a positive integer; a distance between remaining warp yarns that are not pushed by the conductive structures is defined as D, where W1>W2> . . . Wn>D.

In some embodiments, two of the warp yarns closest to each of the conductive structures among the warp yarns pushed by the conductive structures are defined as closest warp yarns, and one of the warp yarns closest to each of the closest warp yarns among the warp yarns pushed by the conductive structures is defined as second-closest warp yarns; the conductive structures push the closest warp yarns to move away from the conductive structures, such that the weft yarns form a first compliance adjustment section between each of the closest warp yarns and each of the conductive structures; a residual force of the conductive structures pushing the closest warp yarns prompts the closest warp yarns to push the second-closest warp yarns to move away from the conductive structures, such that the weft yarns form a second compliance adjustment section between each of the second-closest warp yarns and each of the closest warp yarns; a width of the first compliance adjustment section is defined as W1, and a width of the second compliance adjustment section is defined as W2, where W1>W2>D.

In some embodiments, the damper further comprises at least four tin soldering parts, which are formed at both ends of the conductive structures by soldering with tin, respectively.

In some embodiments, a material of the core thread is cotton.

In some embodiments, the metal yarns are in a count of seven.

The effects of the present invention are that: by utilizing the weft yarns to fix the multifilament threads, so that the sewing thread is not required at all, hence the manufacturing steps are reduced and the manufacturing cost of the damper are lowered.

Furthermore, the weft yarns are utilized to fix the multifilament threads, in the process of thermoforming, the multifilament threads are ensured not to shift, and after being cut, the conductive structures are ensured to be in the optimal position.

Further, the first compliance adjustment sections can offset the rigidity brought by the conductive structures so as to reduce hardness, and can further increase the overall elasticity and toughness of the conductive structures and the weft yarns passing through the conductive structures, thereby enhancing the compliance of the conductive structures and the weft yarns passing through the conductive structures. Therefore, the first compliance adjustment sections can prevent the conductive structures from compromising the flexibility and vibration uniformity of the damper.

Furthermore, the compliance adjustment sections other than the first compliance adjustment sections (i.e., the second compliance adjustment section, the third compliance adjustment section, . . . , and the n^{th} compliance adjustment section) can increase the rigidity of the warp yarns and the weft yarns around the conductive structures so as to increase the hardness, and can further reduce the elasticity and toughness of the warp yarns and the weft yarns around the conductive structures, thereby enhancing the compliance of the warp yarns and the weft yarns around the conductive structures. Therefore, these compliance adjustment sections can ensure that the warp yarns and the weft yarns around the conductive structures remain stable without excessive deformation under large amplitudes; in addition, more compliance adjustment sections there are, the more significant the above effects become.

In addition, the conductive structures are in wide, thin and flat shape, and due to the weaving method for the metal yarns, the metal yarns are exposed to outside without being covered by other metal yarns, such that the heat generated is easy to dissipate, and there is no problem of heat accumulation so that the conductive structures will not overheat.

Moreover, the conductive structures are in wide, thin and flat shape, and only protrude slightly from the surface of the main body, so that the risk of being crushed by the mold is relatively low.

Also, the tin soldering part can prevent the ends of the conductive structures from spreading apart, and can be directly joined at the contact points of the connecting terminals and the coil of the voice coil.

It is worth mentioning that the inner layer of each metal yarn is a core thread, and the outer layer of each metal yarn is a metal layer, which can not only reduce the costs, but also maintain a certain level of electrical conductivity.

It is also worth mentioning that, due to the weaving method for the metal yarns, only a count of metal yarns of seven is required to weave a multifilament thread, which is then cut into two conductive structures, so that the manufacturing cost is relatively low.

### BRIEF DESCRIPTION OF THE DRAWINGS

FIG. 1 is a flow diagram of the method of the present invention.

FIG. 2 is a cross-sectional view of step S10 of the method of the present invention.

FIG. 3 is a schematic view of step S20 of the method of the present invention.

FIG. 4 is a cross-sectional view taken along line VI-VI of FIG. 3.

FIG. 5 is a perspective view of step S30 of the method of the present invention.

FIG. 6 is a perspective view of step S40 of the method of the present invention.

FIG. 7 is a perspective view of step S50 of the method of the present invention.

FIG. 8 is a schematic view of step S60 of the method of the present invention.

FIGS. 9A and 9B are schematic views of step S70 of the method of the present invention.

FIG. 10 is a schematic view of step S80 of the method of the present invention.

FIG. 11 is a schematic view of step S90 of the method of the present invention.

FIG. 12A is a perspective view of the damper of the present invention.

FIG. 12B is a schematic view of region A in FIG. 12A.

FIG. 12C is a schematic view of region B in FIG. 12A.

FIG. 13 is a perspective view of the loudspeaker of the present invention.

FIG. 14 is an exploded view of the loudspeaker of the present invention.

FIG. 15 is a cross-sectional view of the loudspeaker of the present invention.

### DETAILED DESCRIPTION OF THE PREFERRED EMBODIMENT

Herein after, a more detailed description of the implementation of the present invention is made with reference to the drawings and reference symbols, such that those skilled in the art can implement it after studying this specification.

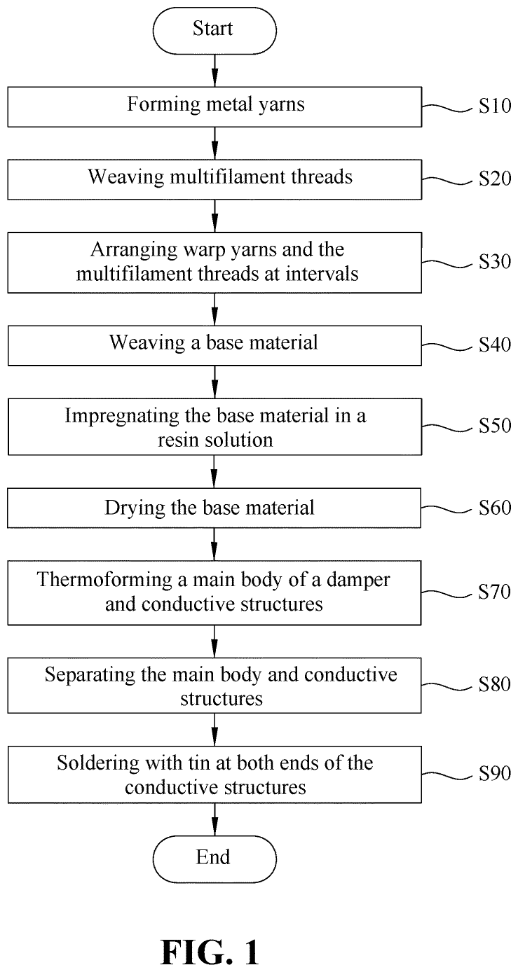

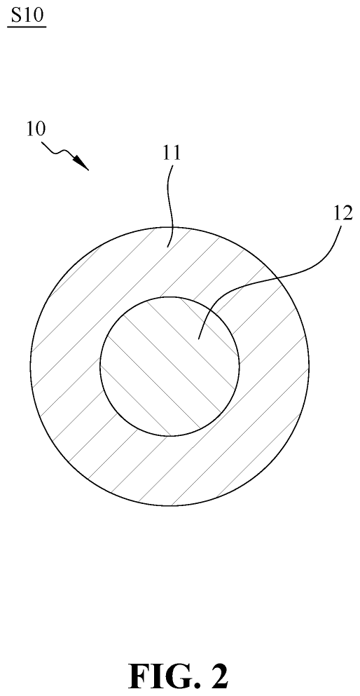

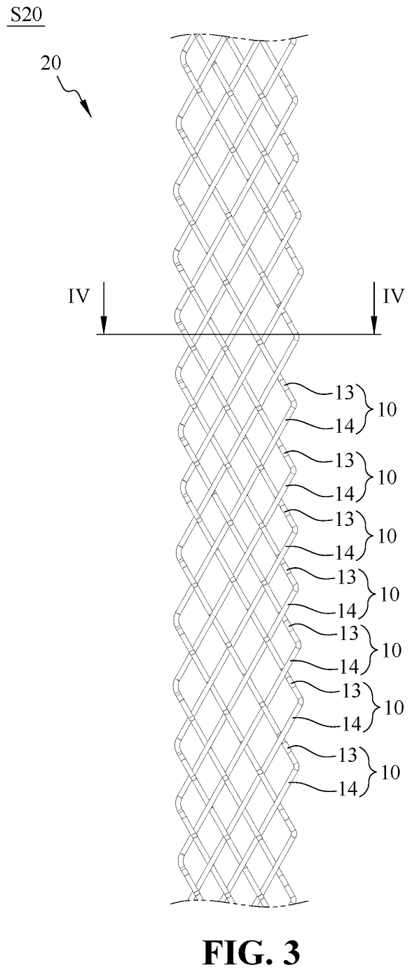

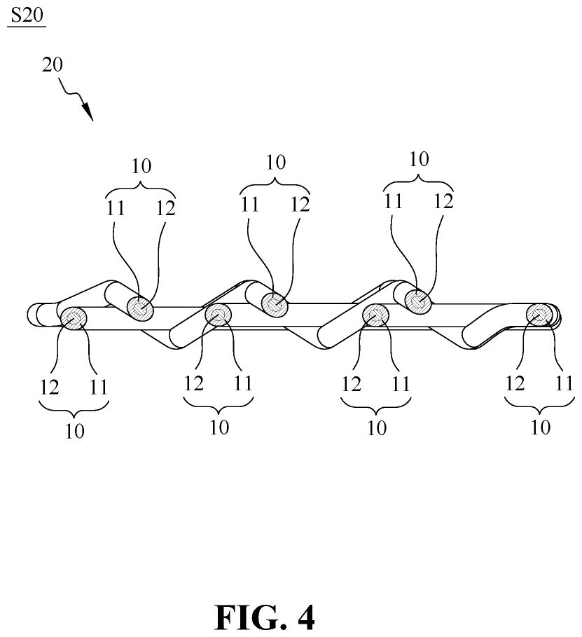

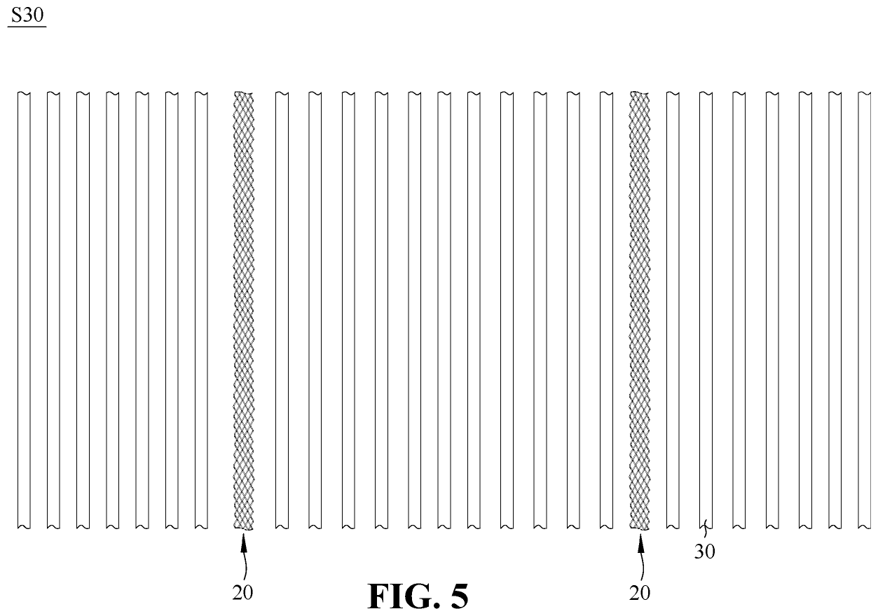

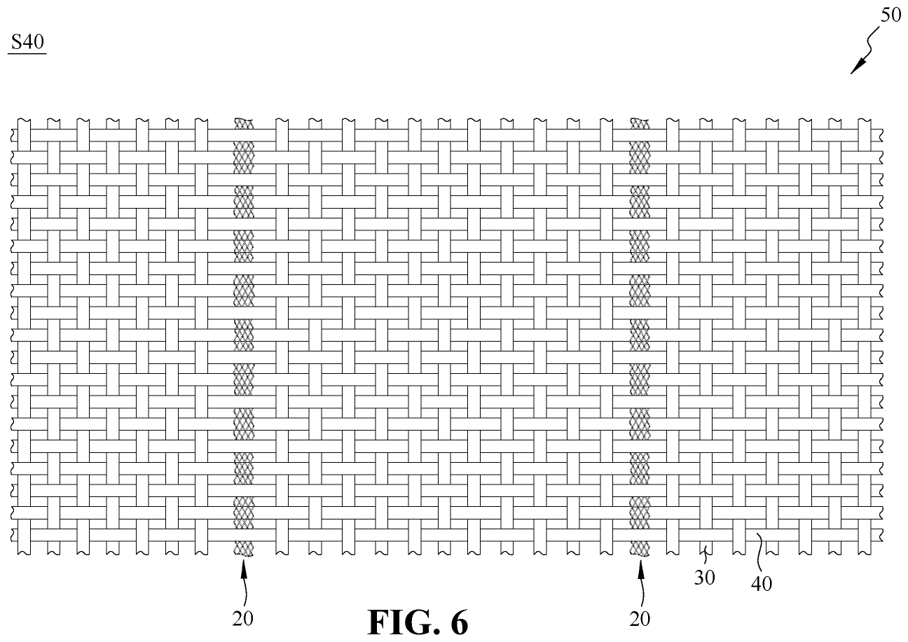

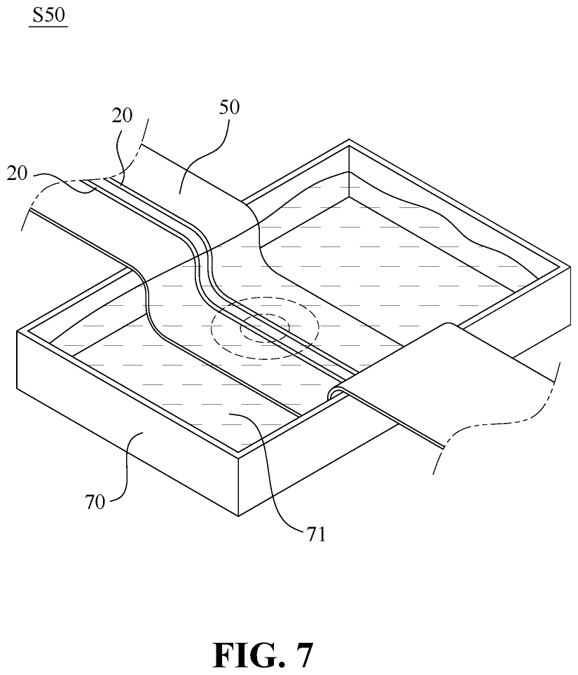

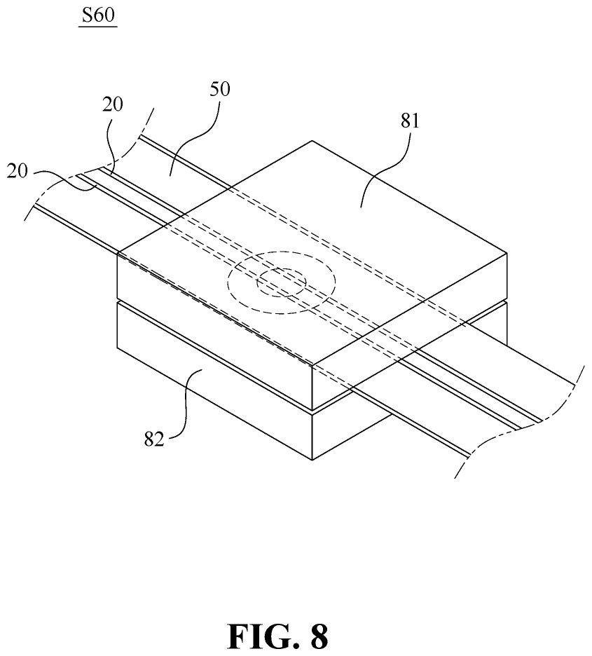

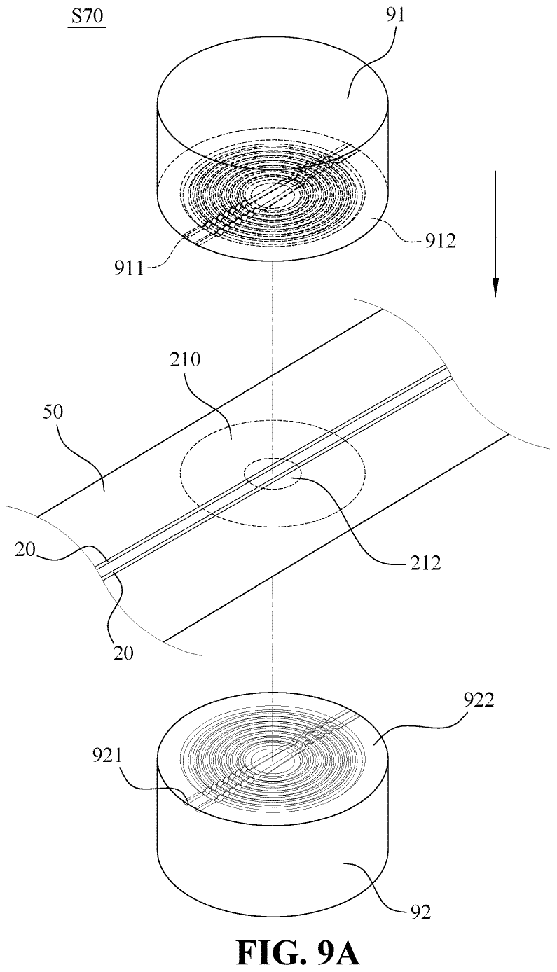

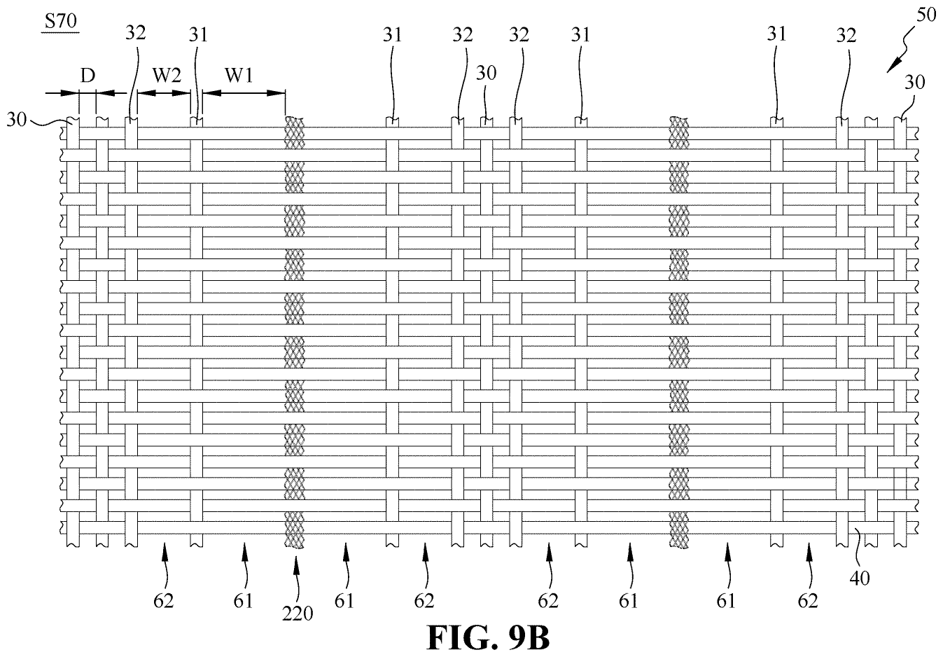

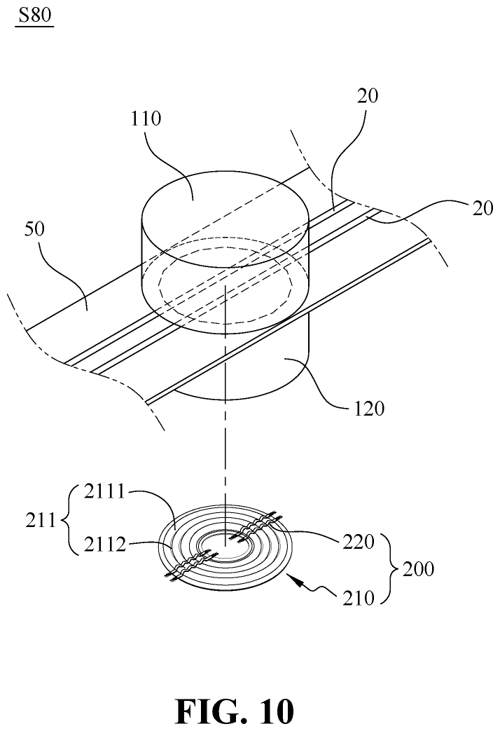

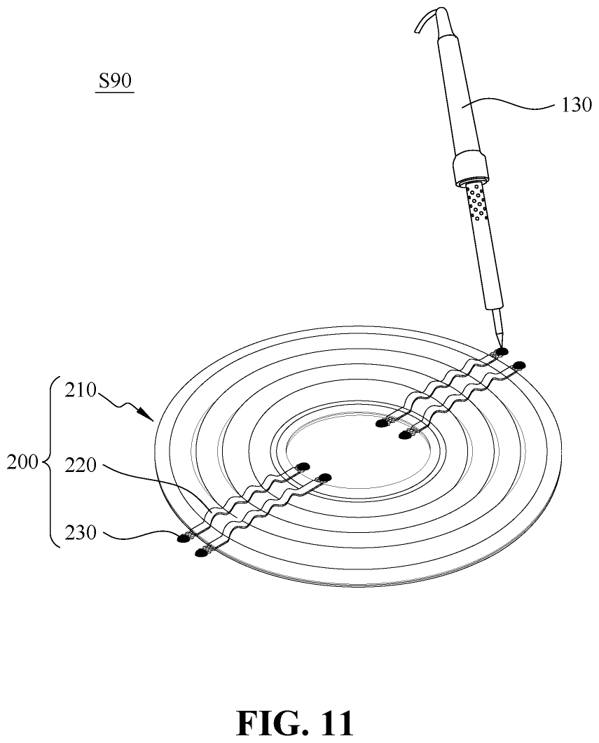

FIG. 1 is a flow diagram of the method of the present invention, FIG. 2 is a cross-sectional view of step S10 of the method of the present invention, FIG. 3 is a schematic view of step S20 of the method of the present invention, FIG. 4 is a cross-sectional view taken along line VI-VI of FIG. 3, FIG. 5 is a perspective view of step S30 of the method of the present invention, FIG. 6 is a perspective view of step S40 of the method of the present invention, FIG. 7 is a perspective view of step S50 of the method of the present invention, FIG. 8 is a schematic view of step S60 of the method of the present invention, FIGS. 9A and 9B are schematic views of step S70 of the method of the present invention, FIG. 10 is a schematic view of step S80 of the method of the present invention, and FIG. 11 is a schematic view of step S90 of the method of the present invention. The present invention provides a method for manufacturing a damper having conductive structures with the wide, thin and flat shape, comprising steps S10 to S90:

In the step S10, as shown in FIGS. 1 and 2, a plurality of metal yarns 10 are formed by covering an outer surface of a core thread 12 with a metal layer 11 for each metal yarn 10. More specifically, the core thread 12 may be made of a non-conductive material, such as cotton, which has a lower cost than the metal layer 11, and a good support effect to the metal layer 11. The metal layer 11 may be made of a material having electrical conductivity, such as copper, aluminum, silver, other metals or alloys.

In the step S20, as shown in FIGS. 1, 3 and 4, multifilament threads 20 with a wide, thin and flat shape are woven by interweaving a plurality of first interwoven parts 13 of the plurality of metal yarns 10 with a plurality of second interwoven parts 14 of the plurality of metal yarns 10 for each multifilament thread 20; wherein both ends of each of the first interwoven parts 13 are respectively connected to one of the second interwoven parts 14, the first interwoven parts 13 are parallel to each other, the second interwoven parts 14 are parallel to each other, and an extension direction of the first interwoven parts 13 is different from that of the second interwoven parts 14. Preferably, the metal yarns 10 are in a count of seven.

In the step S30, as shown in FIGS. 1 and 5, a plurality of warp yarns 30 and two multifilament threads 20 are arranged at intervals on a weaving machine (not shown), wherein both ends of the warp yarns 30 and the multifilament threads 20 are fixed on the weaving machine, such that the warp yarns 30 and the multifilament threads 20 extend straightly and are parallel to each other.

In the step S40, as shown in FIGS. 1 and 6, a base material 50 is woven by interweaving a plurality of weft yarns 40 with the warp yarns 30 and the multifilament threads 20 by using the weaving machine.

In the step S50, as shown in FIGS. 1 and 7, the base material 50 is impregnated in a resin solution 71 in a resin tank 70, such that the multifilament threads 20, the warp yarns 30 and the weft yarns 40 adsorb the resin and are adhered with the resin.

In the step S60, as shown in FIGS. 1 and 8, the base material 50 is dried by utilizing the temperature of a first baking plate 81 and a second baking plate 82 to remove the moisture and volatile substances in the resin on the base material 50; and the resin penetrates into the base material 50 and is adhered onto the multifilament threads 20, the warp yarns 30 and the weft yarns 40, so as to form a solid resin layer (not shown).

In the step S70, as shown in FIGS. 1 and 9A, the base material 50 is placed between a first mold 91 and a second mold 92 in a manner that the multifilament threads 20 are aligned with two grooves 911 of the first mold 91 and two grooves 921 of the second mold 92; when the first mold 91 and the second mold 92 fit together, a pressing surface 912 of the first mold 91 and a forming surface 922 of the second mold 92 jointly pressurize the base material 50 to form a plurality of wave portions 211 (see FIG. 10) and a center hole pre-cut area 212 of a main body 210 of a damper 200, wherein each wave portion 211 comprises a crest 2111 and a trough 2112, at the same time, the multifilament threads 20 are located in the grooves 911 of the first mold 91 and the grooves 921 of the second mold 92, and the pressing surface 912 and the forming surface 922 jointly pressurize the multifilament threads 20 to form two conductive structures 220 with a wide, thin and flat shape (see FIG. 9B); and the first mold 91 and the second mold 92 are heated to 190-270 °C by using a heating device (not shown), the resin can be soften due to the high temperature of the first mold 91 and the second mold 92, such that the resin can be melt and then fill up the gaps, and thus respective parts of the resin are connected with each other to form a final morphology of the solid resin layer, so as to cover the surfaces of the warp yarns 30, the weft yarns 40 and the conductive structures 220 of the main body 210. As shown in FIG. 9B, under influence of temperature and pressure, the conductive structures 220 push a plurality of the warp yarns 30 close to the conductive structures 220 to move away from the conductive structures 220, such that a plurality of compliance adjustment sections are formed between the warp yarn 30 closest to the conductive structures 220 and the conductive structures 220, as well as between the warp yarns 30 pushed by the conductive structures 220. Widths of the compliance adjustment sections are defined as W1, W2, . . . , and Wn, respectively, according to their proximity to the conductive structures 220, where n≥1 and n is a positive integer; and a distance between remaining warp yarns 30 that are not pushed by the conductive structures 220 is defined as D, where W1>W2> . . . >Wn>D. In a preferred embodiment, as shown in FIG. 9B, two of the warp yarns 30 closest to each of the conductive structures 220 among the warp yarns 30 pushed by the conductive structures 220 are defined as closest warp yarns 31, and one of the warp yarns 30 closest to each of the closest warp yarns 31 among the warp yarns 30 pushed by the conductive structures 220 is defined as second-closest warp yarn 32; the conductive structures 220 push the closest warp yarns 31 to move away from the conductive structures 220, such that the weft yarns 40 form a first compliance adjustment section 61 between each of the closest warp yarns 31 and each of the conductive structures 220; and a residual force of the conductive structures 220 pushing the closest warp yarns 31 prompts the closest warp yarns 31 to push the second-closest warp yarns 32 to move away from the conductive structures 220, such that the weft yarns 40 form a second compliance adjustment section 62 between each of the second-closest warp yarns 32 and each of the closest warp yarns 31. Specifically, because the warp yarns 30 around the conductive structures 220 are not constrained by penetration or curing of the adhesive, during the process of thermoforming the damper 200 on the base material 10, based on the shape of the conductive structures 220, the temperature and pressure from the first mold 91 and the second mold 92 allow the conductive structures 220 to transmit a pushing force to the surrounding warp yarns 30. This pushing force is first transmitted to the closest warp yarns 31 to form the first compliance adjustment section 61; then the residual pushing force is further transmitted to the second-closest warp yarns 32 to form the second compliance adjustment section 62; and no pushing force is transmitted to the remaining warp yarns 30 that are not pushed by the conductive structures 220. The width of the first compliance adjustment section 61 is defined as W1, the width of the second compliance adjustment section 62 is defined as W2, and the distance between the remaining warp yarns 30 that are not pushed by the conductive structures 220 is defined as D, where W1>W2>D. The magnitudes of these distances are proportional to the pushing force of the conductive structures 220 being sequentially transmitted to the closest warp yarn 31, the second-closest warp yarn 32, and the remaining warp yarns 30 that are not pushed by the conductive structures 220.

In the step S80, as shown in FIGS. 1 and 10, the main body 210 is separated from the base material 50 and the conductive structures 220 are separated from the multifilament threads 20, simultaneously by jointly using the first cutting tool 110 and the second cutting tool 120

In the step S90, as shown in FIGS. 1 and 11, the conductive structures 220 are soldered with tin at both ends by using a soldering tool 130 to form eight tin soldering parts 230.

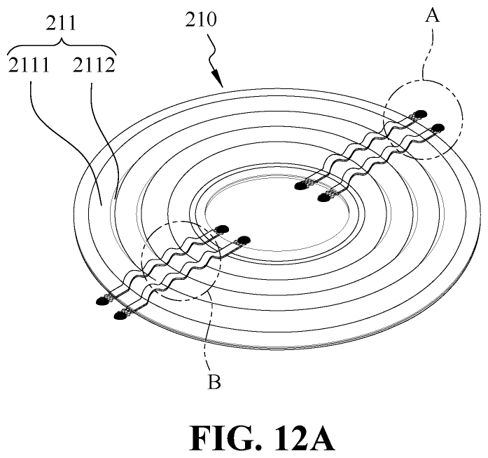

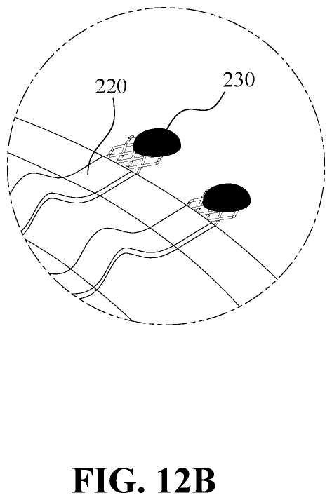

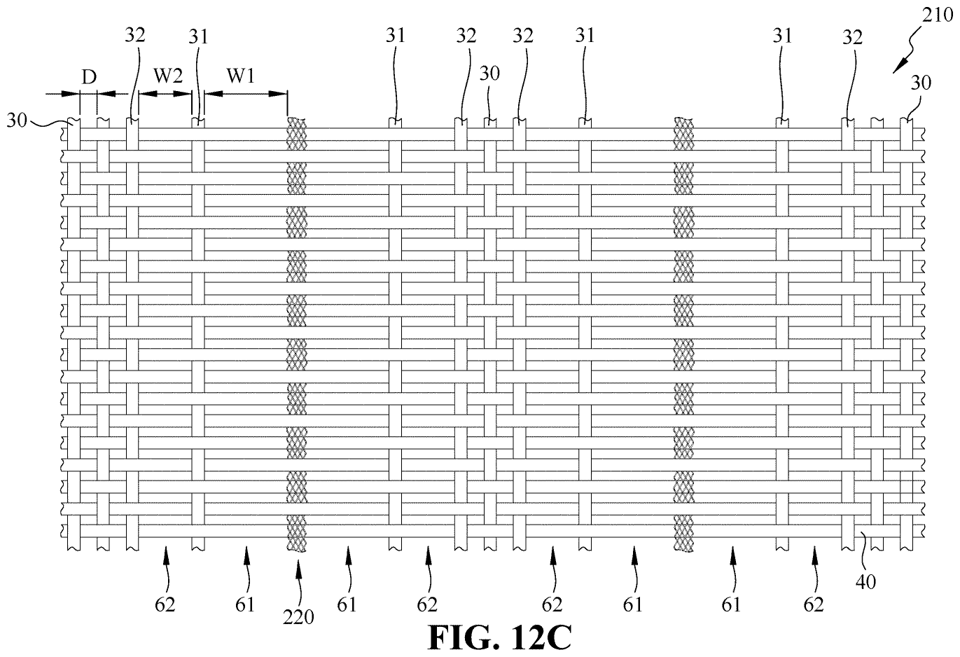

FIG. 12A is a perspective view of the damper 200 of the present invention. FIG. 12B is a schematic view of region A in FIG. 12A. FIG. 12C is a schematic view of region B in FIG. 12A. As shown in FIGS. 12A, 12B and 12C, with reference to FIGS. 2 to 11, the present invention provides a damper 200 having conductive structures 220 with a wide, thin and flat shape, which comprises a main body 210, four conductive structures 220 and eight tin soldering parts 230.

As shown in FIG. 6, the main body 210 is formed by interweaving a plurality of warp yarns 30 and a plurality of weft yarns 40.

As shown in FIG. 6, each of the conductive structures 220 is in a wide, thin and flat shape, the conductive structures 220 and the warp yarns 30 are arranged at intervals, extend straight, parallel to each other, and are interwoven with the weft yarns 40. Specifically, as shown in FIGS. 3 and 4, each of the conductive structures 220 is a multifilament thread 20 with a wide, thin and flat shape, and the multifilament thread 20 is formed by interweaving a plurality of first interwoven parts 13 of a plurality of metal yarns 10 and a plurality of second interwoven parts 14 of the plurality of metal yarns 10. As shown in FIG. 2, each of the metal yarns 10 is formed by covering an outer surface of a core thread 12 with a metal layer 11. As shown in FIGS. 3 and 4, both ends of each of the first interwoven parts 13 are respectively connected to one of the second interwoven parts 14, the first interwoven parts 13 are parallel to each other, the second interwoven parts 14 are parallel to each other, and an extension direction of the first interwoven parts 13 is different from that of the second interwoven parts 14.

As shown in FIGS. 12A and 12B, the tin soldering parts 230 are formed at both ends of the conductive structures 220 by soldering with tin, respectively.

As shown in FIGS. 12A and 12C, under influence of temperature and pressure, the conductive structures 220 push a plurality of the warp yarns 30 close to the conductive structures 220 to move away from the conductive structures 220, such that a plurality of compliance adjustment sections are formed between the warp yarn 30 closest to the conductive structures 220 and the conductive structures 220, as well as between the warp yarns 30 pushed by the conductive structures 220. Widths of the compliance adjustment sections are defined as W1, W2, . . . , and Wn, respectively, according to their proximity to the conductive structures 220, where n≥1 and n is a positive integer; and a distance between remaining warp yarns 30 that are not pushed by the conductive structures 220 is defined as D, where W1>W2> . . . >Wn>D. In a preferred embodiment, two of the warp yarns 30 closest to each of the conductive structures 220 among the warp yarns 30 pushed by the conductive structures 220 are defined as closest warp yarns 31, and one of the warp yarns 30 closest to each of the closest warp yarns 31 among the warp yarns 30 pushed by the conductive structures 220 is defined as second-closest warp yarn 32; the conductive structures 220 push the closest warp yarns 31 to move away from the conductive structures 220, such that the weft yarns 40 form a first compliance adjustment section 61 between each of the closest warp yarns 31 and each of the conductive structures 220; and a residual force of the conductive structures 220 pushing the closest warp yarns 31 prompts the closest warp yarns 31 to push the second-closest warp yarns 32 to move away from the conductive structures 220, such that the weft yarns 40 form a second compliance adjustment section 62 between each of the second-closest warp yarns 32 and each of the closest warp yarns 31. A distance between each of the closest warp yarns 31 and each of the conductive structures 220 is defined as W1, and a distance between each of the second-closest warp yarns 32 and each of the closest warp yarns 31 is defined as W2; and a distance between remaining warp yarns 30 that are not pushed by the conductive structures 220 is defined as D, where W1>W2>D.

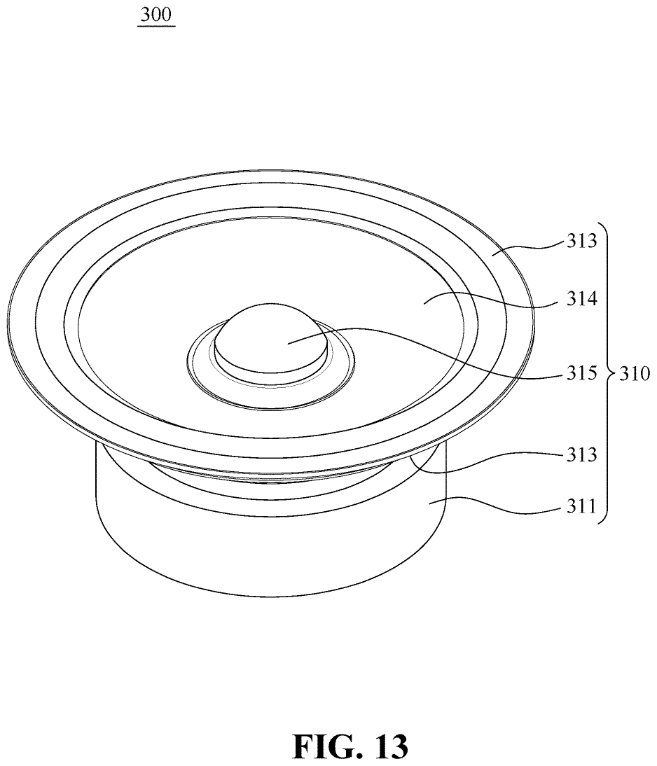

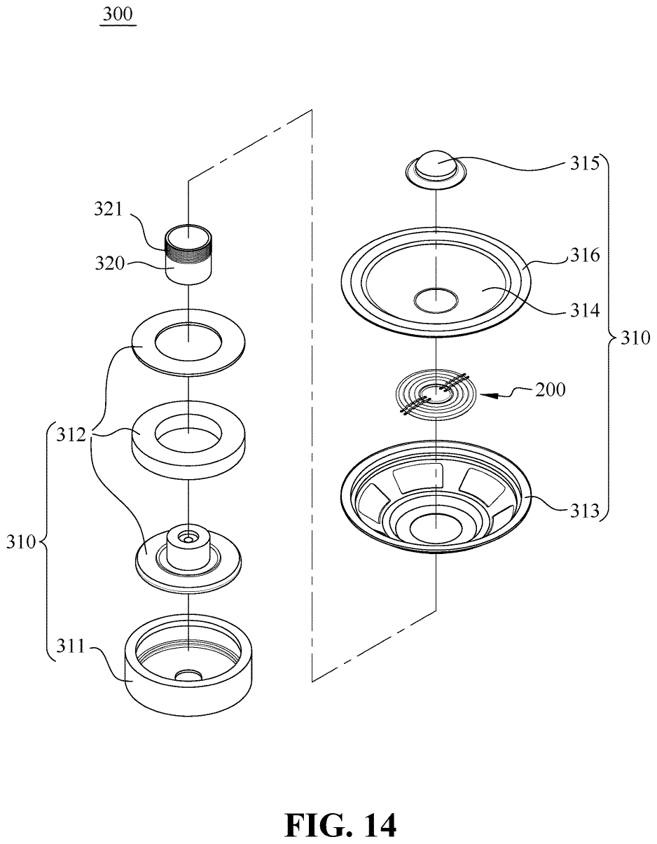

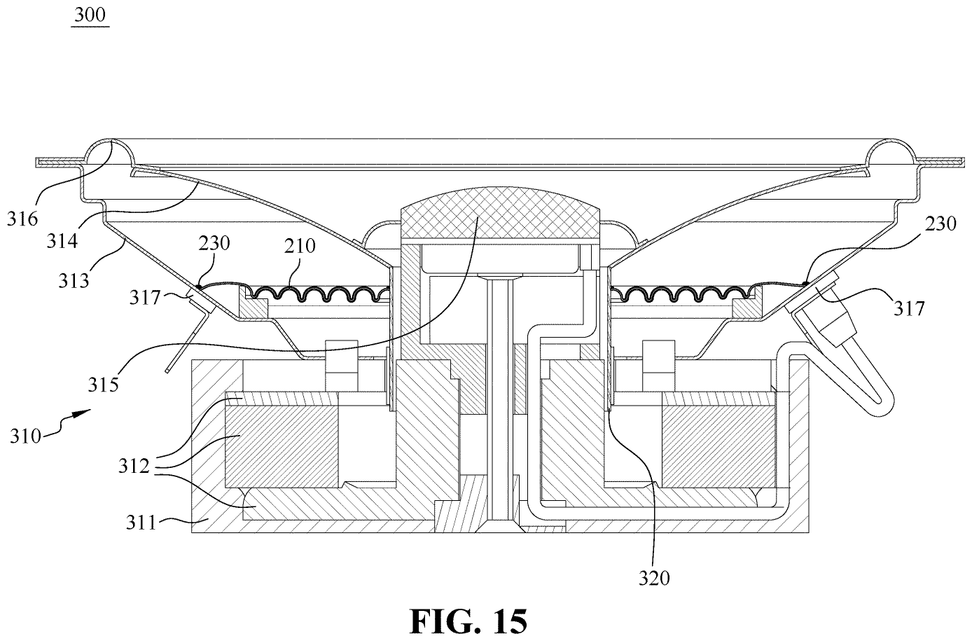

FIG. 13 is a perspective view of the loudspeaker 300 of the present invention, FIG. 14 is an exploded view of the loudspeaker 300 of the present invention, and FIG. 15 is a cross-sectional view of the loudspeaker 300 of the present invention. As shown in FIGS. 13, 14 and 15, the present invention provides a loudspeaker 300, which comprises a loudspeaker body 310, a voice coil 320 and the damper 200 mentioned above. The loudspeaker body 310 includes a base 311, a magnetic circuit device 312, an outer frame 313, a diaphragm 314, a dust cover 315, a suspension 316 and a plurality of connecting terminals 317. The magnetic circuit device 312 is disposed on the base 311. The voice coil 320 is disposed in the magnetic circuit device 312 and has a coil 321. The outer frame 313 is disposed above the magnetic circuit device 312. The diaphragm 314 is sleeved at the voice coil 320. The dust cover 315 is disposed at a center hole of the diaphragm 314. The suspension 316 is disposed between the top edge of the diaphragm 314 and the outer frame 313. Each connecting terminal 317 is disposed on the outer frame 313 and has a contact point. The damper 200 is sleeved at the voice coil 320. Both ends of the conductive structures 220 are respectively joined to the contact points of the connecting terminals 317 and the coil 321 of the voice coil 320 through the tin soldering parts 230.

In summary, the method of the present invention utilizes the weft yarns 40 to fix the multifilament threads 20, so that the sewing thread is not required at all, hence the manufacturing steps are reduced and the manufacturing cost of the damper 200 are lowered.

Furthermore, the method of the present invention utilizes the weft yarns 40 to fix the multifilament threads 20, such that the multifilament threads 20 can be firmly fixed at the optimal position. In the process of thermoforming, the multifilament threads 20 are ensured not to shift. After the threads 20 are cut, the conductive structures 220 are ensured to be in the optimal position, thereby enhancing the common resonance efficiency of the damper 200, the voice coil 320 and the diaphragm 314, such that the sound quality of each speaker 300 can be kept consistent.

Further, the first compliance adjustment sections 61 can offset the rigidity brought by the conductive structures 220 so as to reduce hardness, and can further increase the overall elasticity and toughness of the conductive structures 220 and the weft yarns 40 passing through the conductive structures 220, thereby enhancing the compliance of the conductive structures 220 and the weft yarns 40 passing through the conductive structures 220. Therefore, the first compliance adjustment sections 61 can prevent the conductive structures 220 from compromising the flexibility and vibration uniformity of the damper 200.

Furthermore, the compliance adjustment sections other than the first compliance adjustment sections (i.e., the second compliance adjustment section 62, the third compliance adjustment section, . . . , and the n^{th} compliance adjustment section) can increase the rigidity of the warp yarns 30 and the weft yarns 40 around the conductive structures 220 so as to increase the hardness, and can further reduce the elasticity and toughness of the warp yarns 30 and the weft yarns 40 around the conductive structures 220, thereby enhancing the compliance of the warp yarns 30 and the weft yarns 40 around the conductive structures 220. Therefore, these compliance adjustment sections can ensure that the warp yarns 30 and the weft yarns 40 around the conductive structures 220 remain stable without excessive deformation under large amplitudes; in addition, more compliance adjustment sections there are, the more significant the above effects become.

In addition, the conductive structures 220 are in wide, thin and flat shape, and due to the weaving method for the metal yarns 10, the top surface and the bottom surface of the first interwoven part 13 and the second interwoven part 14 of each metal yarn 10 are all exposed to outside without being covered by other metal yarns 10, such that the heat generated is easy to dissipate, and there is no problem of heat accumulation so that the conductive structures 220 will not overheat.

Moreover, the conductive structures 220 are in wide, thin and flat shape, and only protrude slightly from the surface of the main body 210, so that the risk of being crushed by the first mold 91 and the second mold 92 is relatively low. For the sake of safety, the first mold 91 and the second mold 92 both form with a plurality of grooves 911, 921, and the grooves 911, 921, which can protect the conductive structures 220, and ensure that the conductive structures 220 will not be crushed by the first mold 91 and the second mold 92. Since the conductive structures 220 only protrude slightly from the surface of the main body 210, corresponding to the grooves 911, 921, the molds do not need to be drilled with a too deep depth, thereby reducing the manufacturing cost thereof.

Also, the tin soldering parts 230 not only can prevent the ends of the conductive structures 220 from spreading apart, but also can be directly joined at the contact points of the connecting terminals 317 and the coil 321 of the voice coil 320. Even if for a long-term use, the fixing effect of the tin soldering parts 230 maintains unchanged, and the ends of the conductive structures 220 will not be separated from the contact points of the connecting terminals 317 and the coil 321 of the voice coil 320.

It is worth mentioning that the inner layer of each metal yarn 10 is a core thread 12, and the outer layer of each metal yarn 10 is a metal layer, which can not only reduce the costs, but also maintain a certain level of electrical conductivity.

It is also worth mentioning that, due to the weaving method for the metal yarns 10, only a count of metal yarns of seven (minimum count) is required to weave a multifilament thread 20, and which is then cut into two conductive structures 220, so that the manufacturing cost is relatively low.

Those mentioned above are only preferred embodiments for explaining the present invention but intend to limit the present invention in any forms, so that any modifications or change relating to the present invention made under the same spirit of the present invention should be included in the claimed scope of the present invention.

What is claimed is:

1. A method for manufacturing a damper having conductive structures with a wide, thin and flat shape, comprising the following steps:
forming a plurality of metal yarns by covering an outer surface of a core thread with a metal layer for each metal yarn;
weaving multifilament threads with a wide, thin and flat shape by interweaving a plurality of first interwoven parts of the plurality of metal yarns with a plurality of second interwoven parts of the plurality of metal yarns for each multifilament thread; wherein both ends of each of the first interwoven parts are respectively connected to one of the second interwoven parts, the first interwoven parts are parallel to each other, the second interwoven parts are parallel to each other, and an extension direction of the first interwoven parts is different from that of the second interwoven parts;
arranging a plurality of warp yarns and two multifilament threads at intervals with at least two of the warp yarns located between the multifilament threads, wherein the warp yarns and the multifilament threads extend straightly and are parallel to each;
weaving a base material by interweaving a plurality of weft yarns with the warp yarns and the multifilament threads;
impregnating the base material in a resin solution;
drying the base material;
thermoforming a main body of the damper on the base material, and two conductive structures with the wide, thin and flat shape on the multifilament threads, simultaneously, wherein under influence of temperature and pressure, the conductive structures push the warp yarns close to the conductive structures to move away from the conductive structures, such that a plurality of compliance adjustment sections are formed between the warp yarns closest to the conductive structures and the conductive structures, as well as between the warp yarns pushed by the conductive structures; widths of the compliance adjustment sections are defined as W1, W2, . . . , and Wn, respectively, according to their proximity to the conductive structures, where n≥1 and n is a positive integer; a distance between remaining warp yarns that are not pushed by the conductive structures is defined as D, where W1>W2> . . . >Wn>D; and
separating the main body from the base material, and the conductive structures from the multifilament threads, simultaneously.

2. The method according to claim 1, wherein in the step of thermoforming the main body of the damper on the base material, two of the warp yarns closest to each of the conductive structures among the warp yarns pushed by the conductive structures are defined as closest warp yarns, and one of the warp yarns closest to each of the closest warp yarns among the warp yarns pushed by the conductive structures is defined as second-closest warp yarns; the conductive structures push the closest warp yarns to move away from the conductive structures, such that the weft yarns form a first compliance adjustment section between each of the closest warp yarns and each of the conductive structures; a residual force of the conductive structures pushing the closest warp yarns prompts the closest warp yarns to push the second-closest warp yarns to move away from the conductive structures, such that the weft yarns form a second compliance adjustment section between each of the second-closest warp yarns and each of the closest warp yarns; a width of the first compliance adjustment section is defined as W1, and a width of the second compliance adjustment section is defined as W2, where W1>W2>D.

3. The method according to claim 1, wherein after the step of separating the main body from the base material, the method further comprises: soldering with tin at both ends of the conductive structures to form at least four tin soldering parts.

4. The method according to claim 1, wherein a material of the core thread is cotton.

5. The method according to claim 1, wherein the metal yarns are in a count of seven.

6. The method according to claim 1, wherein in the step of thermoforming the main body of the damper on the base material, the base material is placed between a first mold and a second mold in a manner that the multifilament threads are aligned with two grooves of the first mold and two grooves of the second mold, and when the first mold and the second mold fit together, a pressing surface of the first mold and a forming surface of the second mold jointly pressurize the base material to form a plurality of wave portions and a center hole pre-cut area of the main body; and wherein each wave portion comprises a crest and a trough, the multifilament threads are located in the grooves of the first mold and the grooves of the second mold, and the pressing surface and the forming surface jointly pressurize the multifilament threads to form the conductive structures.

7. A damper having conductive structures with a wide, thin and flat shape, comprising:
a main body, which is formed by interweaving a plurality of warp yarns and a plurality of weft yarns; and
two conductive structures with a wide, thin and flat shape, wherein the conductive structures and the warp yarns are arranged at intervals with at least two of the warp yarns located between the conductive structures, extend straight, parallel to each other, and are interwoven with the weft yarns;
wherein each of the conductive structures is a multifilament thread with a wide, thin and flat shape, and the multifilament thread is formed by interweaving a plurality of first interwoven parts of a plurality of metal yarns and a plurality of second interwoven parts of the plurality of metal yarns;
wherein each of the metal yarns is formed by covering an outer surface of a core thread with a metal layer;
wherein both ends of each of the first interwoven parts are respectively connected to one of the second interwoven parts, the first interwoven parts are parallel to each other, the second interwoven parts are parallel to each other, and an extension direction of the first interwoven parts is different from that of the second interwoven parts; and
wherein under influence of temperature and pressure, the conductive structures push the warp yarns close to the conductive structures to move away from the conductive structures, such that a plurality of compliance adjustment sections are formed between the warp yarns closest to the conductive structures and the conductive structures, as well as between the warp yarns pushed by the conductive structures; widths of the compliance adjustment sections are defined as W1, W2, . . . , and Wn, respectively, according to their proximity to the conductive structures, where n≥1 and n is a positive integer;
a distance between remaining warp yarns that are not pushed by the conductive structures is defined as D, where W1>W2> . . . >Wn>D.

8. The damper according to claim 7, wherein two of the warp yarns closest to each of the conductive structures among the warp yarns pushed by the conductive structures are defined as closest warp yarns, and one of the warp yarns closest to each of the closest warp yarns among the warp yarns pushed by the conductive structures is defined as second-closest warp yarns; the conductive structures push the closest warp yarns to move away from the conductive structures, such that the weft yarns form a first compliance adjustment section between each of the closest warp yarns and each of the conductive structures; a residual force of the conductive structures pushing the closest warp yarns prompts the closest warp yarns to push the second-closest warp yarns to move away from the conductive structures, such that the weft yarns form a second compliance adjustment section between each of the second-closest warp yarns and each of the closest warp yarns; a width of the first compliance adjustment section is defined as W1, and a width of the second compliance adjustment section is defined as W2, where W1>W2>D.

9. The damper according to claim 7, further comprising at least four tin soldering parts, which are formed at both ends of the conductive structures by soldering with tin, respectively.

10. The damper according to claim 7, wherein a material of the core thread is cotton.

11. The damper according to claim 7, wherein the metal yarns are in a count of seven.
